(19) United States
(12) Patent Application Publication
(10) Pub. No.: US 2002/0076018 A1
(43) Pub. Date: Jun. 20, 2002

(54) Pre-purchased phone minutes service

(76) Inventors: Diane K. Banks, Basking Ridge, NJ (US); Roy S. Coutinho, Whitehouse Station, NJ (US); Donnie Henderson, Manalapan, NJ (US); Ram N.S. Rathore, Randolph, NJ (US)

Correspondence Address: KENYON & KENYON, 1500 K STREET, N.W., SUITE 700, WASHINGTON, DC, 20005, US

(21) Appl. No.: 09/736,426

(22) Filed: Dec. 15, 2000

(51) Int. Cl. H04M 15/00

(52) U.S. Cl. 379/114.2; 379/114.01; 379/114.09; 379/114.17

(57) ABSTRACT

The present invention is directed to methods and apparatus for enabling a subscriber to pre-purchase usage time from a telephone company or a consolidator at substantially a discounted rate and use the pre-purchased usage time against subsequent long distance telephone calls.

### TECHNICAL FIELD

The claimed invention is related to the field of telecommunication, and more specifically, to a method and a system wherein a subscriber can acquire pre-purchased minutes from the telephone company at a discounted rate and subsequently use the pre-purchased usage time to make long distance calls.

### BACKGROUND OF THE INVENTION

The popularity of prepaid telephone cards has been soaring partly due to the discounted rate they offer to the consumer and the potential for the cost savings that they provide. Prepaid calling cards are typically sold in $5, 10, 20 and 50 denominations from convenient stores and other outlets. The prepaid cards provide an advantage in that the card user can comparison shop so as to obtain the lowest available price for the long distance call prior to making the telephone call. For example, a caller interested in making a long distance call to Sweden can shop around for the prepaid calling card that offers the best long distance rate for Sweden. In this example, the caller may not be distracted by the fact that the card has a relatively higher rate for calls to Canada, so long as the rate is advantageous for calls to Sweden.

Notwithstanding these advantages, the prepaid phone cards have several disadvantages, some of which are disclosed in U.S. Pat. No. 5,991,748, which is incorporated herein for background information. For example, prepaid calling cards generally include a toll-free telephone number and dialing instructions for accessing a host computer system. A unique authorization code is also associated with each remote account. When a customer uses the prepaid card to place a long distance call, the toll-free number is first dialed to access the host system, which manages the remote accounts. Thus, a disadvantage of using calling cards is the need to dial a sequence of numbers just to connect with the host system. Dialing the required digits is cumbersome and mistake-prone.

After connecting with host system, the calling party must then enter a predetermined authorization number to access the database. In some instances the authorization number is written on the prepaid card. This method is especially disadvantageous should the card be lost or stolen. To overcome this problem, many prepaid cards require the customer to contact the host system and activate the card before using the card. However, having to call and activate the account adds another step that a customer has to perform before using the prepaid cards. Moreover, should the customer inadvertently forget the authorization number, the phone card would be useless. Hence, while this method lends some protection for lost or stolen prepaid cards, it brings about several other disadvantages.

Once the card is activated and the consumer has the activation code, she must then contact the host telephone number and request that dialing the destination number would connect a long distance call. As the call progresses, the long distance telephone charges attributed to the telephone call are deducted from the prepaid account balance. The call connection may be terminated by the calling party or by the host system when the account is fully consumed. Generally, when the prepaid account balance is depleted, the user must discard the spent card and purchase a new card. One obvious disadvantage is that the call is terminated without giving the caller the option to add value to the prepaid amount and maintain the long distance connection. In addition, having to constantly purchase new prepaid cards is inconvenient to the consumer. Discarding spent cards is also wasteful and harmful to the environment. More importantly, the cost of printing and redistributing new cards adds to the cost borne by merchant and consumer alike.

Other known schemes provide prepaid cards capable of being regenerated by increasing the account balance. With this format, a consumer regenerates the card by connecting to the host computer, entering a credit card number and expiration date, home zip code, and the desired regenerate amount. The consumer then directs the host system to charge funds to the credit card and deposit the funds into the prepaid card account. Such methods for regenerating prepaid phone cards are disadvantageous because the consumer must enter a cumbersome amount of data by way of DTMF from the telephone set. A high risk of erroneously entered data is also present, causing the incorrect charge to the consumer's or someone else's credit card. Moreover, regenerating prepaid cards must take place before or after placing phone calls. Known prepaid calling cards do not allow a card to be regenerated during a phone call connection to a called destination or in response to a host system's notification that the account balance is about to be depleted.

### SUMMARY OF THE INVENTION

The present invention is directed to methods and apparatus for integrating a virtual phone card with traditional telephone services. Specifically, the invention is directed to enabling a subscriber to pre-purchase usage time from a service provider at a substantially discounted rate and use the pre-purchased usage time against subsequent long distance telephone calls.

According to one embodiment of the present invention, a subscriber contacts the telecommunication company (wire line or otherwise) and contracts for a finite block if usage time (hereinafter “pre-purchased time”) at a discounted rate (for example, a rate which is less expensive than the subscriber's existing rate for a particular long distance call). The service provider then credits the subscriber's account with the pre-existing time and bills the subscriber for the transaction in the subscriber's regularly scheduled billing statement. The pre-purchased time is activated immediately and the subscriber can place long distance telephone calls immediately thereafter. As such, the subscriber is able to simply dial the desired party's telephone number and enjoy the advantage of a discounted rate without having to physically purchase a phone card, activate the phone card, and dial excessive number of digits before connecting to the desired party.

In addition, unlike the conventional telephone cards, the call will not automatically disconnect upon expiration of the allotted time. Rather, at the subscriber's election the telephone call may continue at the subscriber existing rate or at a rate different than the discounted rate. Finally, the present invention can also be adapted for use with conventional out-of-band signaling systems.

### BRIEF DESCRIPTION OF THE DRAWINGS

The various features of the invention will best be appreciated by simultaneous reference to the description which follows and the accompanying drawings, in which:

FIG. 1 is a flowchart outlining the process according to one embodiment of the present invention;

FIG. 2 is a flowchart illustrating the steps taken to determine whether the caller is using pre-purchased minutes according to one embodiment of the invention;

FIG. 3 is a flowchart representing the decision making process according to one embodiment of the invention; and

FIG. 4 illustrates an exemplary embodiment of a telephone network in accordance with this invention.

FIG. 5 is an exemplary embodiment of an SS7 network adapted for implementing the embodiment of the invention.

### DETAIL DESCRIPTION

The present invention is directed to methods and apparatus for enabling a subscriber to pre-purchase usage time from a telephone company or a consolidator at a substantially discounted rate and use the pre-purchased usage time against future long distance telephone calls. The methods and apparatus of the present invention substantially eliminate the need to, among others, physically purchase prepaid phone cards, activate the prepaid card and contact a host computer prior to calling the desired third-party.

In a preferred embodiment of the invention a telephone company sales, or contracts to sale, a block of long distance time to an existing subscriber at a discounted rate which is less expensive than the subscriber's existing rate. For example, a telephone company can sell a thirty minute block of long distance time to Germany for a per-minute rate, which is less than the subscriber's existing rate. In this manner, if at any time the subscriber dials the country code associated with Germany, the telephone company will implement a routine wherein (i) identifies the subscriber, (ii) determines whether the subscriber has pre-purchased time for Germany, and if yes, (iii) implements steps to connect the telephone call to Germany for the discounted rate, or the remainder thereof. On the other hand, if the subscriber's account does not show a pre-purchased block of time, or if the block of time is for some other country, then the call is connected and the subscriber is billed at the established rate.

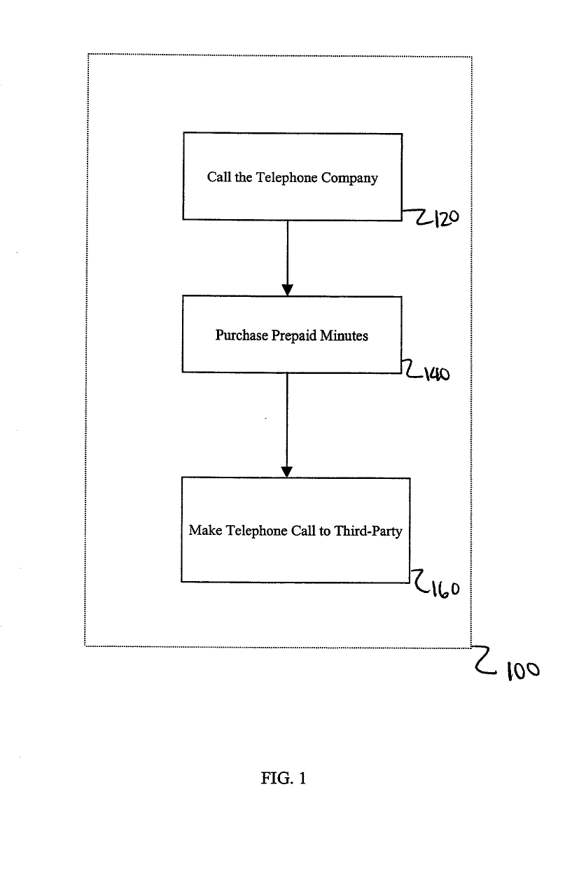

FIG. 1 is a flowchart outlining the process 100 according to one embodiment of the present invention. Referring to FIG. 1, in step 120, the subscriber contacts the telephone company and pre-purchases a block of time at a given rate at step 140. Thereafter, the subscriber can make long distance telephone call and have the minutes deducted from the pre-purchase time.

A telephone company can be any entity in a position to either directly, or indirectly, control the cost of the long distance telephone calls. For example, the telephone company can be any one of the established telephone companies e.g., AT&T, MCI, Pacific Bell, etc. Alternatively, a telephone company can be a consolidator that purchases a large block of time from a traditional telephone company at a substantially discounted rate and then resells the time to a plurality of customers at a more expensive rate. In the preferred embodiment of the invention, the subscriber contacts a telephone company who is the subscriber's primary service provider. In this manner the subscriber has an existing relationship with the service provider such that the subscriber can be identified by an existing account number and a network address. Thus, once the subscriber has purchased a block of pre-purchased usage time at the discounted rate, the subscriber's account is credited with the pre-purchased number of minutes and the pre-purchased rate. As subsequent long distance telephone calls are made, they are deducted from the pre-purchased minutes until the pre-purchased account is substantially depleted.

For billing purposes, the telephone company will simply charge the cost of pre-purchased block of time to the subscriber's regularly schedule statement. Accordingly, the cost of the pre-purchase usage time appears in the subscriber's subsequent telephone statement. This method has the added advantage that the subscriber and the telephone company need not engage in a credit card transaction over the telephone. In addition, the subscriber can postpone paying for the virtual phone card until the statement's due date. This method also saves the telephone company the transaction cost associated with engaging in a credit card purchase.

The virtual phone card can be purchased for any amount and can offer any long distance rate contemplated by the telephone company or negotiated by the subscriber and the telephone company. For example, a subscriber may wish to purchase a 30 minute, or $30, block of long distance usage time for calls to Australia. Once the telephone company and the subscriber reach an agreement as to the long distance rate and once the transaction is completed, the subscriber's subsequent thirty minutes of long distance call to Australia will be deducted against the virtual phone card. Similarly, the subscriber can pre-purchase usage time for domestic long distance at a discounted rate. Thus, if for example, the subscriber's long distance plan offers domestic long distance calls for 9 cents per minute, the subscriber can pre-purchase a 60 minute block of domestic long distance for 6 cents per minute.

In addition to purchasing a first block of time, the subscriber can contract for subsequent blocks of time at different rates. For example, the purchaser of a 120 minute block of long distance time to Australia can contract for additional blocks at different rates. Thus, once the first threshold is reached (i.e., the subscriber has exceeded the 120 minutes—or $60-block of long distance call), the communication continues with the rate bumped to a second rate until a second threshold is reached whereby the communication continues at a third rate and so on. In this example, the subscriber can contract with the telephone company for a first 120 minute-block at $60, to be followed by a second block of time for 60 minutes at $40, and a third block of time for 30 minutes at $25. In practice once the call exceeds the first threshold of 120 minutes, the rate is increased to $0.66 per minute; and once the communication exceeds the second threshold of 180 minutes (i.e., the sum of the 120 minute block+the 60 minute block in this case), the rate is once again increased to $0.83 per minute for the subsequent 30 minutes. Clearly, the rate could be bumped to a higher or lower price, as specified by the provider, as the call exceeds the various thresholds.

Unless the subscriber is calling from a remote location, the virtual phone card can be activated immediately upon purchase from the telephone company, or in one embodiment of the invention, immediately after verification of purchase by an independent auditor. Thus, a subscriber can place a long distance call immediately after purchasing a virtual phone card and without having to do any more than picking up the handset and dialing the desired long distance telephone number.

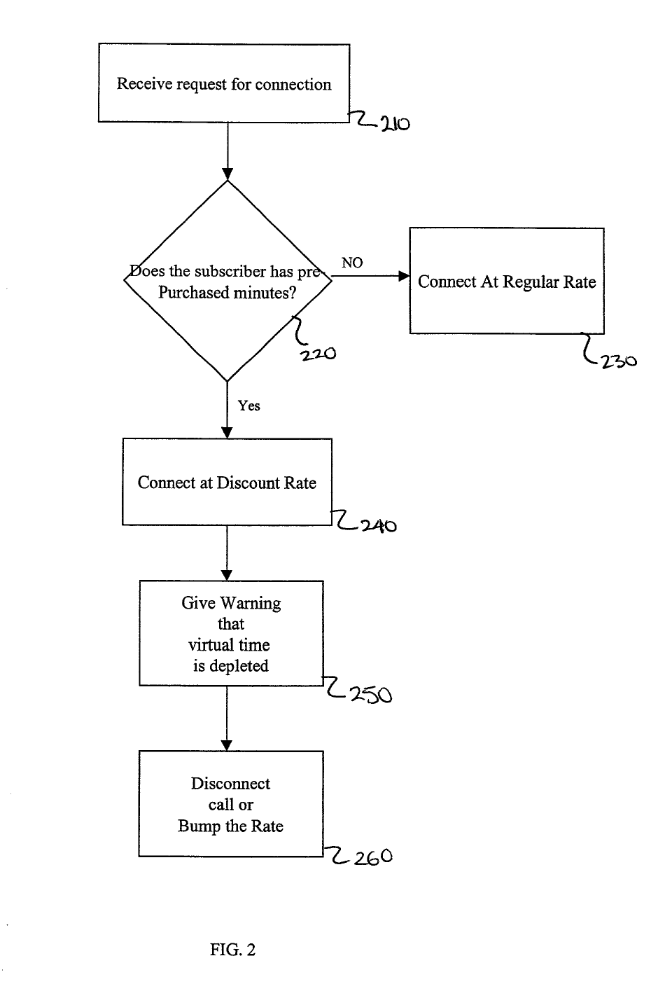

FIG. 2 is a flowchart illustrating the steps taken to determine whether the caller is using pre-purchased minutes according to one embodiment of the invention. In step 210, the telephone company receives a request for long distance connection. The request can be in the form of a signal that results from the subscriber generating a dial tone. In another embodiment of the invention, the long distance code (e.g., 1 or 011 plus the country code) can be used to signal the subscriber's intent to make a long distance telephone call. In yet another embodiment of the invention, the subscribers can be given a host telephone number to call before dialing the desired party's telephone number.

Upon receiving subscriber's request for a long distance connection, the telephone company queries its database to find out whether the subscriber has pre-purchased minutes as reflected in Step 220. In one embodiment of the invention, (“ANI”) can be used for identifying the caller and transmitting information relating to the caller's billing number. If the subscriber does not have pre-purchased usage time, the call is connected at the conventional rate (step 230). On the other hand, if the subscriber has pre-purchased usage time at a discount rate, the call is connected at the discount rate (step 240). Once the call is connected, the telephone company can keep track of the time remaining in the virtual phone card (step 250), and give warning to the subscriber as the pre-purchased usage time draws near completion. For example, the telephone company can send a voice signal audible only to the subscriber and stating that 5, 3 or 1 minute remains before the expiration of the virtual phone card (step 250). Once the pre-purchased usage time is exhausted, the telephone company may decide whether to disconnect the call or to maintain the connection but charge at a different long distance rate (step 260).

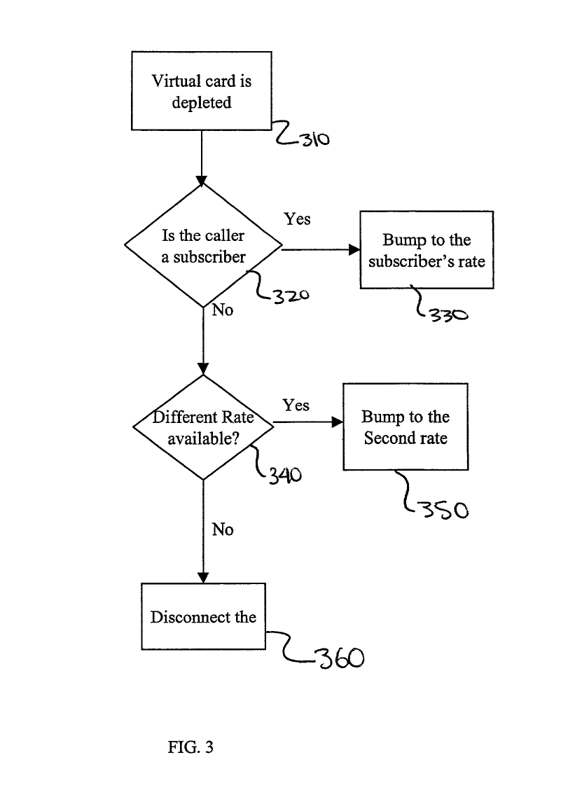

FIG. 3 is a flowchart representing the decision making process according to one embodiment of the invention. After the pre-purchased time has been used (step 310), the telephone company determines whether the caller is a subscriber in step 320. If the caller is a subscriber, one option would be to allow the telephone conversation to continue at a different billing rate. In step 330 for example, the billing rate can be bumped to the subscriber's existing rate for that call. In an alternative embodiment, per agreement with the subscriber, the telephone company may continue the conversation but bill at an overtime rate or secondary rate that is different from the pre-purchased rate or the subscriber's existing rate.

In one embodiment of the invention, a call processor at the service provider would, in response to a call originating from a subscriber, would authenticate the subscriber as one having a virtual phone card for the desired destination. This verification can be implemented by analyzing the ANI of the called party against a first database to determine whether the subscriber has contracted for the pre-paid calling feature. If enabled, a second database could be searched to determine whether the call satisfies parameters of the feature as recorded in the subscriber's profile. If the call satisfies the parameters, the processor would connect the call and charge fees associated with the call to the subscriber's account. The process would also keep track of the duration of the call and, if needed, bump or reduce the rate according to the pre-paid calling feature. In this manner, the fee associated with the call is charged to the pre-paid account until aggregate fees charged to the account exceed a first pre-determined threshold. On the other hand, if the call is not authenticated, the call processor connects the call at the subscriber's existing rate.

If the telephone company is not the subscriber's service provider, then in step 340 a query is made as to whether there is any agreement for overtime connection. If such an agreement exists, the telephone company will maintain the connection and bill the remainder of the long distance call at an overtime rate. If there is no such provision then the connection can be terminated (step 360).

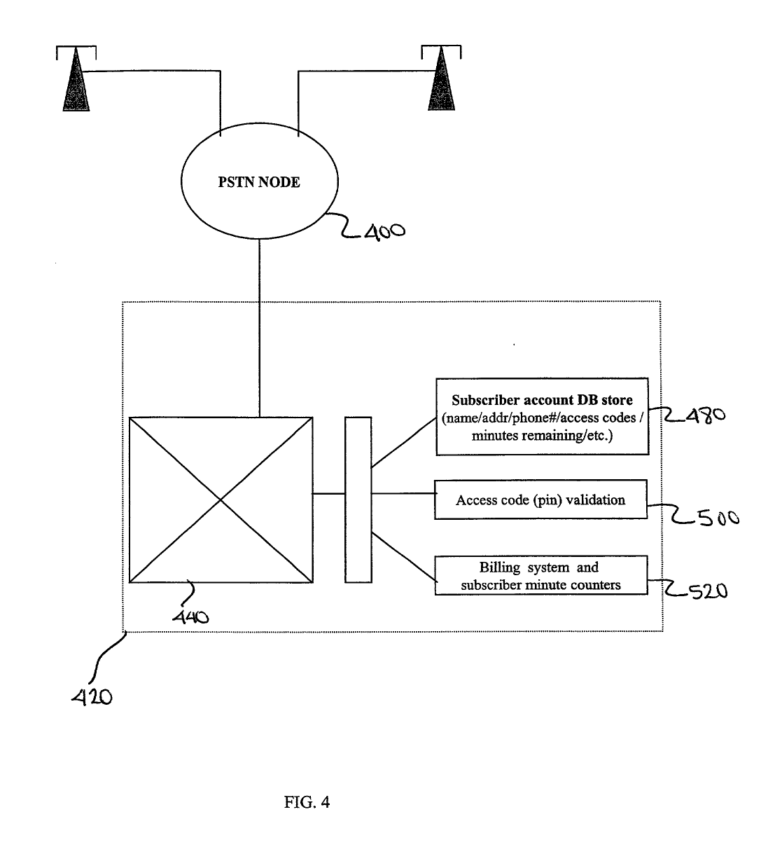

FIG. 4 illustrates an exemplary embodiment of a telephone network in accordance with this invention. This system permits a calling party to make a telephone call using pre-purchased minutes in accordance with the embodiments of the present invention. The calling party is connected to the called number through one or more nodes in a public switched telephone network (PSTN). One of those PSTN nodes 400 is shown in FIG. 4. Node 400 may comprise a telecommunication switching system located in a network provided by a local exchange center (LEC) such as Regional Bell Operating Companies. Alternatively, the switching system may be a switching system located in the network of a long distance carrier such as AT&T. There usually are a plurality of such nodes 400 in a typical PSTN. The architecture of the exemplary embodiment of FIG. 4, also includes a platform or adjunct 420, connected to network node 400. The platform may be located in the same place as network 400, or platform 420 may be located in a remote location from network 400. Platform 420 implements the virtual phone card system of the present invention in conjunction with the usual equipment contained in the rest of the PSTN. In addition, platform 420 contains an end office digital switching system 440, connected to network node 400. Switching system 440 performs call processing functions for calls between platform 420 and network node 400. The call processing functions of switching system 440 are controlled by a host computer or processor 460. Processor 460 can be connected to databases 480, 500 and 520. In the embodiment of FIG. 4, database 420 can store, for example, customer information such as name, address, telephone number(s), access code (if needed), minutes remaining in the virtual card, etc. The system of the present invention can be advantageously implemented with a secondary processor and a secondary database for validating subscriber's access code should the subscriber be calling from a remote telephone station.

In the embodiment of FIG. 4, database 500 can associate with processor 460 to ensure access code validation. This is of particular interest where the subscriber has a different carrier than the company issuing the virtual phone card or when the subscriber is calling from a different location than what is associated with her existing account. In this embodiment, processor 460 accesses database 500 and verifies the access code before proceeding with connecting the call.

Billing system and subscriber counter 520 is schematically illustrated as one unit in the embodiment of FIG. 4, although it can comprise several components placed in different physical locations. The function of the billing system 520 is to keep track of the virtual phone card by subtracting the used minutes from that available in the client's pre-purchased plan. Any conventional minute counter that can interact with processor 460, or with an independent processor, can be used.

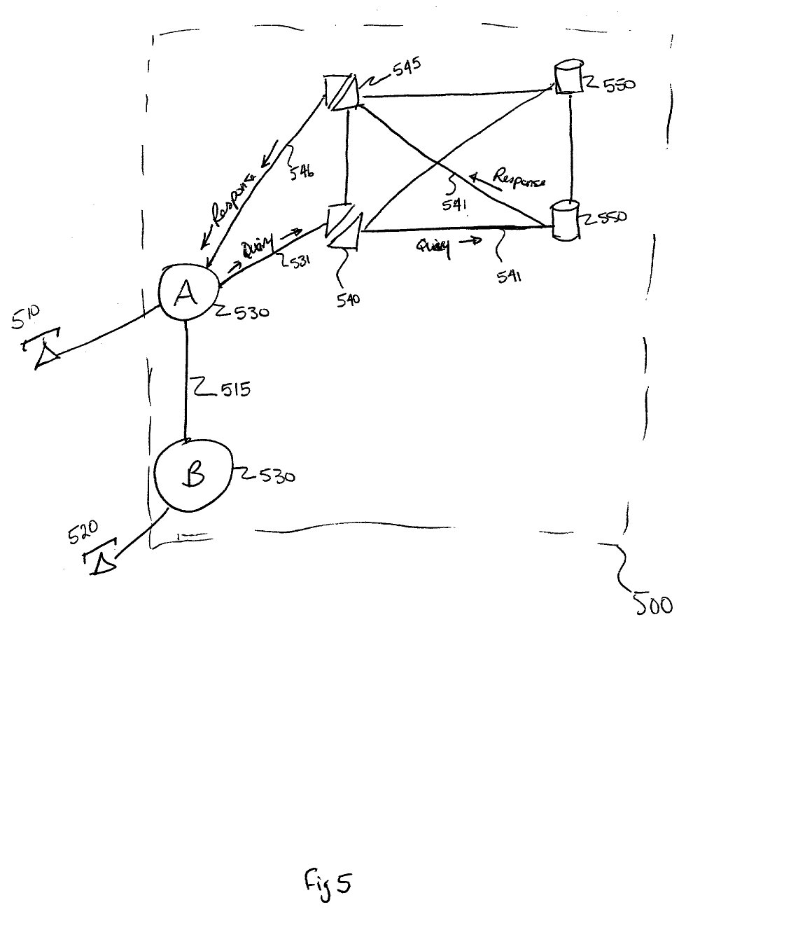

The pre-purchased phone minute service of the present invention is especially adaptable for use with the out-of-band signaling systems. One such system is the conventional Signaling System 7 or SS7 by illuminate SM. This signaling systems provide an architecture for performing out-of-band signaling to support establishing telephone calls, billing, routing and information-exchange function of the PSTN. Out-of-band signaling is network signaling that does not take place over the same path as the conversation. FIG. 5 is an exemplary embodiment of an SS7 network adapted for implementing the embodiment of the invention.

Referring to FIG. 7, subscriber 510 invokes her pre-purchased telephone minute service by signaling the network through dialing a long-distance telephone number. Signal Switching Point (“SSP”) A routes a query relating to the subscriber's account to Signal transfer Point (“STP”) 540 vial signaling link 531. STP 540 is a packet switch of the SS7 network, which receives and routes incoming signal messages, for example an inquiry, toward its proper destination. STP 540 routes the signal inquiry to Signal Control Point (“SCP”) 550 via signaling line 541. SCP 550 is a database providing information necessary for advanced call-processing capabilities. For example, SCP 550 can retrieve the subscriber pre-purchased minutes and signal a response to the STP 545, which, in turn, signals SSPA to originate a telephone call to destination B through trunk line 515. As described a processor can be adapted to monitor the length of the conversation and perform the necessary billing functions. The embodiment of FIG. 5 includes redundancy typical of the SS7 systems. It will be noted that FIG. 5 is presented as an illustrative embodiment and should not be construed as limiting the invention.

What is claimed is:

1. A method for a service provider to provide a subscriber with pre-purchased telephone usage time comprising:
contracting with the subscriber for a finite usage time at a first rate,
allowing the subscriber to place a telephone call to a called party,
charging the cost of the telephone call against the first rate, and
upon exceeding the finite usage time allowing the telephone call to continue at a second rate.

2. The method of claim 1, wherein the service provider is the subscriber's existing carrier and associates the subscriber with an existing network address.

3. The method of claim 1, wherein upon the expiration of the finite usage time, the telephone call is ended.

4. The method of claim 1, wherein the first rate is a discounted rate.

5. The method of claim 1, wherein the service provider company associates the usage time the subscriber's existing account.

6. The method of claim 5, wherein the service provider charges the cost of the usage time against the subscriber's existing account.

7. The method of claim 1, further comprising signaling the subscriber when the usage time is about to expire.

8. The method of claim 1, wherein the usage time is associated with specific area codes.

9. The method of claim 1 adapted for implementation with an out-of-band signaling system.

10. A method for a subscriber to make telephone calls with pre-purchased telephone usage time comprising:
contracting for usage time from a telephone company at a first rate,
establishing a telephone communication with a called party,
deducting a cost of the communication at the first rate against the pre-purchased usage time,
wherein upon expiration of the finite usage time, the telephone communication continues at a second rate.

11. The method of claim 10, wherein the telephone company is the subscriber's current carrier associating the subscriber with an existing network address.

12. The method of claim 10, wherein the first rate is a discounted rate.

13. The method of claim 10, wherein the telephone company associates the usage time with the subscriber's existing account.

14. The method of claim 10, further comprising the step of signaling the subscriber when the pre-purchased usage time is about to expire.

15. The method of claim 10, further comprising the step of disconnecting the telephone communication upon expiration of the pre-purchased usage time.

16. The method of claim 10, wherein the second rate is the subscriber's pre-existing long distance rate.

17. A system for enabling the use of pre-purchased wire line phone minutes comprising a telephone switching network connected to a processor and a database, wherein said processor identifies a network subscriber's pre-purchased rate over an existing rate.

18. The system of claim 17, wherein said system further comprises a subset of information relating to the subscriber's billing rate, network address, mailing address and access code.

19. The system of claim 17 further comprising a minute counter connected to said processor.

20. The system of claim 17 further comprising a secondary processor and a secondary database for validating the subscriber's access code.

21. The method of claim 17 adapted for an out-of-band signaling system.

22. A method for a subscriber to a wire line telecommunication system to make telephone calls with pre-purchased telephone usage time comprising:
contracting for usage time from a wire line telecommunication company at a first rate,
establishing a wire line telephone communication with a called party deducting a cost of the communication at the first rate against the pre-purchased usage time,
when the usage time for said first rate is exhausted, the communication continues at a second rate.

23. A call processing method comprising:
in response to a call origination request of a subscriber, authenticating the subscriber, and conducting a call between the subscriber and an end point,
wherein the authenticating comprises:
determining whether a subscriber profile indicates that a pre-paid calling feature has been enabled for the subscriber,
if enabled, whether the call satisfies parameters of the feature as recorded in the subscriber profile,
if the call satisfies the parameters, charging fees associated with the call to a prepaid account for the subscriber,
otherwise, charging fees associates with the call to another account for the subscriber.

24. The method of claim 23, wherein fees associated with the call are charged to the pre-paid account until aggregate fees charged to the account exceed a first predetermined threshold.

26. The method of claim 24, wherein after the aggregated fees exceed the threshold, subscriber fees are charged to another account for the subscriber.

27. The method of claim 24, wherein after the aggregated fees exceed the threshold, subscriber fees are charged at a second rate until aggregate charges at the second rate exceed a second threshold.

28. The method of claim 26, wherein after the aggregate fees exceed a second threshold, subscriber fees are charged at a third rate until aggregated charges at the third threshold exceed a third rate.

29. The method of claim 23, wherein said authentication is performed in a signal control point of an out-of-band signaling system.
